(19) United States
(12) Patent Application Publication
(10) Pub. No.: US 2012/0126469 A1
(43) Pub. Date: May 24, 2012

(54) ANTI-VIBRATION LAUNDRY PAD SUB-FLOOR REINFORCEMENT PAD

(76) Inventor: Howard Hassman, Boca Raton, FL (US)

(21) Appl. No.: 12/952,066

(22) Filed: Nov. 22, 2010

(51) Int. Cl. F16F 15/04; F16F 7/00

(52) U.S. Cl. 267/141

(57) ABSTRACT

An anti-vibration pad includes three parts and is an irregular shape with a depth of 3.25 inches, a total length of inches and a width of 28 inches. The device is formed from 4,000 psi concrete with 3/8″ crushed stone, with 18-gauge mesh wire and a polymer coating. Together these materials provide the necessary strength, weight and durability necessary to reinforce the floor below an appliance and effectively absorb the vibration and noise emitted from high-speed washers and other devices.

### FIELD OF THE INVENTION

The present invention relates generally to the fields of construction and home improvement. More particularly, this invention is for use within a residential household or commercial business to eliminate disturbing vibrations caused by washing machines and other such appliances.

### BACKGROUND OF THE INVENTION

As laundry technology progresses machines are being created with increasing power. The consequent increased vibrations and unwanted noise from the ever-increasing power generated by modern washing machines and other such appliances is a source of constant irritation to the users of such machines. For example, washing machines can spin as fast as 1400 RPM and cause disrupting sound and vibration throughout a residence. Noise and vibration of this magnitude can permeate throughout a household, sometimes even affecting the local community, both of which are undesired and unintended consequences of modern appliances. The problem is increased on upper level laundry room floors, leading to intense vibration or movement of the machine, which can result in damage and disruption throughout a home.

It is known that manufacturers are cognizant of the problem due to numerous complaints fielded to both builders and washing machine and dryer manufacturers. The problem of unwanted vibration and noise as well as damage to the washing machine itself and the surrounding wall surfaces and structures is a well-known grievance amongst washing machine owners. Upon learning of the issue, builders and manufacturers alike recommend reinforcing upper level floors. This, however, is a very expensive proposition.

Accordingly, there is an immediate need for improved devices and methods to reduce vibration of household appliances, such as washing machines.

### SUMMARY OF THE INVENTION

The present invention provides devices and methods for minimizing the vibration and noise from heavy household and industrial appliances, and in particular from high-speed washing machines and other machinery. The present invention acts as a reinforcement to the subfloor that allows for absorption of the vibrations and the resulting noise and damage that can occur in a home.

Although not the primary use, the present invention is also useful in damp spaces or areas prone to flooding as the washing machine or other equipment is kept off the floor and will, therefore, not rust from water exposure. This greatly helps extend the longevity of the washing machine or other metal appliance.

One aspect of the present invention provides an irregularly shaped cement pad reinforced with wire mesh and coated with a colored polymer to match a washing machine or other appliance.

Installation of the device underneath a washing machine or appliance and then leveling the washing machine or appliance is simple, unobtrusive and can be done without professional assistance. Embodiments of the present invention empower homeowners to avoid costly and invasive construction to reinforce subflooring as suggested by manufactures that field many complaints about the noise and vibration emitted from high-speed washing machines.

While the elimination of unwanted noise and vibration is one goal of this invention, structural damage to floors, walls, washing machines, cabinets, etc. will also become obsolete as well. The present invention serves to curtail those vibrations by reinforcing the structural integrity of the area underneath the washing machine. By maintain the surrounding structures by way of eliminating unwanted vibrations, this invention also helps to extend the lifetime of the appliance by protecting it from coming into contact with nearby surfaces. Thus, the machine itself and the surrounding structures will additionally be maintained as a result of the effectiveness of this invention.

### BRIEF DESCRIPTION OF THE DRAWINGS

FIG. 1 shows an embodiment anti-vibration pad.

FIG. 2 is a cross-sectional view of the embodiment shown in FIG. 1.

FIG. 3 illustrates usage of an embodiment anti-vibration pad with respect to a washing machine.

### DETAILED DESCRIPTION

In the following, specific reference is drawn to washing machines as devices for which embodiment anti-vibration pads may be employed. It will be appreciated, however, that embodiment anti-vibration pads may be suitably employed with other types of devices as well; washing machines are merely a notable example.

Embodiments of the present invention are able to reduce the vibration caused by washing machines and high-powered devices in a residential environments, and are particularly suitable for a floor higher than ground level. The vibration that comes about as a result of the washing machine's natural cadence and rhythm is often exacerbated when placed and situated on an above-floor level platform. Structures are built in such a way that above-ground levels are not as secure and builders offer the option of a sub-floor to be built in areas in which homeowners place washing machines and high-powered devices. This can become a very cumbersome situation and one in which most, if not all, residential and commercial washing machine owners would like to avoid for the potential costs and time necessary to make these changes.

Because front load washing machines spin as fast as 850-1400 RPM, proper balancing is very critical. As is the case with all residential and commercial use washing machines, if the unit is not balanced properly, the amount of unwanted vibration and noise increases drastically and has the potential for such severe structural damage that the unit and surrounding surfaces are likely to be damaged beyond repair. This problem is increased on upper level floors thus creating vibration or movement of the washing machine or device. Undesired movement of the washing machine in any environment, whether it is a commercial setting or a residential one, could cause a plethora of problems for the owner and lead to some serious problems depending on what is in the immediate vicinity of the machine.

The manufacturers recognize the problem and recommend that home-owners reinforce upper level floors, which is expensive and not practical. Again, the time, cost, effort, and man-power needed to perform such a task is something no residential or commercial washing machine owner would like to deal with, especially when an alternative such as this invention is readily available and easily applied. The process of putting in a sub-floor is invasive and requires professional construction, time and is often quite costly. The present invention allows for the same structural benefit as a constructed sub-floor with no construction and the installation of a device in under ten minutes. The cost benefit analysis of each method of resolution is not comparable on any level and leaves the present invention clearly the most effective and efficient option for resolving unwanted vibration, noise, and structural damage caused by unruly washing machines.

In addition, certain floor surfaces, like ceramic tile, may be uneven, and could cause the washing machine to walk. Any common household or commercial floor surface that a washing machine sits upon is likely to be damaged from a walking machine. Using the present invention will solve walking problems caused by uneven floor surfaces, or severely unbalanced loads. Whereas large-scale structural work was previously necessary to be performed in order to fix the issue in a residential or commercial environment, the present invention makes that unnecessary and easily corrects any number or issues that may be the result of original construction error, such as non-level floors and walls.

The present invention is also helpful in wet or damp areas such as basements by raising a washing machine, dryer, or other appliances and equipment off of a damp floor to prevent rusting. By raising the level of the surface that the washing machine sits upon, all potential floor-level issues such as the aforementioned as well as many more are essentially eliminated and allow for the washing machine unit to sit alone without causing any disturbance to surrounding structures and for it to not be disturbed by any number of potential floor-level problems.

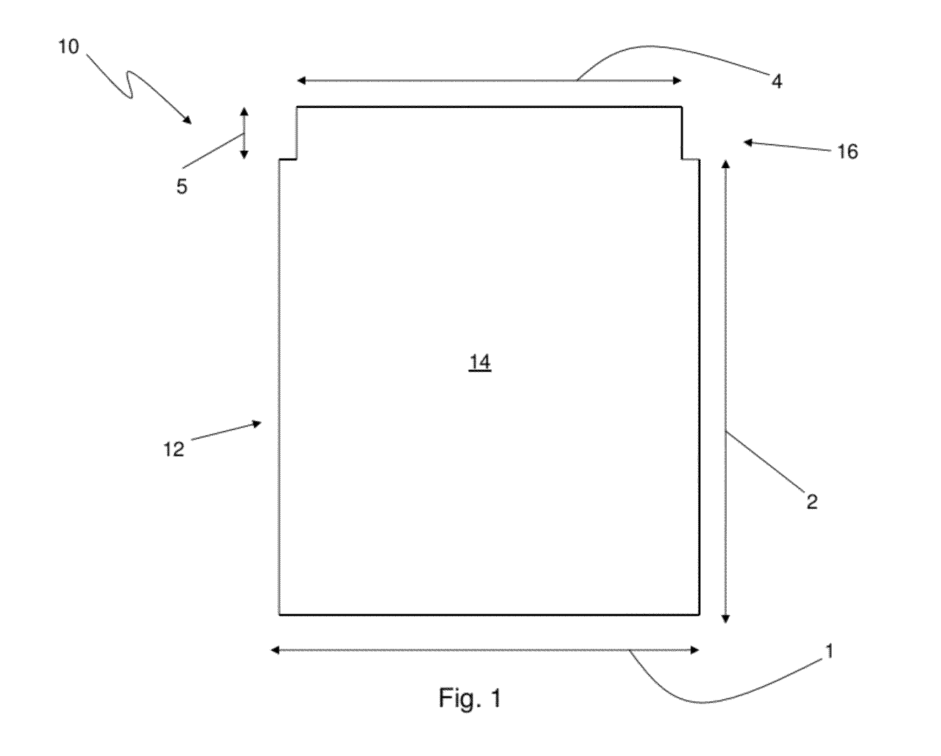

Please refer to FIGS. 1-3. An embodiment device 10 is made from 4,000 psi cement, with ⅜″ crushed stone. However, cement from 2000 psi to 5000 psi may be used, with stone from ¾″ to ⅜″. The device 10 is shaped in such a way as to reinforce the existing beams within a building so as to effectively disperse of the vibration of a machine over a larger surface area and limit or remove excess and disruptive vibration and subsequent noise and damage throughout a residence. The shape of the device 10, as shown in FIG. 1, is extended in the back to lock into the beam at the strongest point—the wall—and allow maximum vibration reduction. Hence, the device 10 has a main body portion 12 that has a flat top surface 14, and an extension portion 16 that has a width that is less than the main body portion 12; the extension portion 16 is integrally formed with the main body portion 14, and protrudes from one side of the main body portion 12, preferably the back side—i.e., the side that will face the wall of the structure. The extension portion 16 is preferably rectangular in shape; however, other shapes may be possible, such a ellipsoid. It is known that the closer a point is to a wall and to a beam the more structurally secure it is and the more weight it can handle. This premise is one of the underlying reasons behind the engineering of the embodiment device 10. The extension portion 16 helps to better disperse the weight of the appliance resting on the device 10, and better insulates the floor or subfloor from vibrations caused by the appliance.

In preferred embodiments the device 10 has a depth (i.e., thickness) 3 of 2 inches to 5 inches, more preferably of 3 inches to 4 inches, more preferably still of 3.25 inches. The main body portion 12 has a length 2 of 32 inches to 38 inches, and preferably of 32 inches. The device 10 has a width 1 of 28 inches to 60 inches. Wider embodiments may be desirable for multiple appliances, such as a washer and drier pair; a single appliance embodiment device 10 preferably has a width of about 28 inches, for example. The extension 16 has a width 4 that is less than the width 1 of the main body portion 12, and can be from 24 inches to 56 inches; typically the width 4 of the extension portion 16 will be about 4 inches less than the width 1 of the main body portion 10. The extension 16 is preferably centered with the main body portion 10; that is, the midpoint of the width 4 of the extension portion 16 is aligned with the midpoint of the width 1 of the main body portion 10. The extension portion 16 has a length 5 of 3 inches to 5 inches.

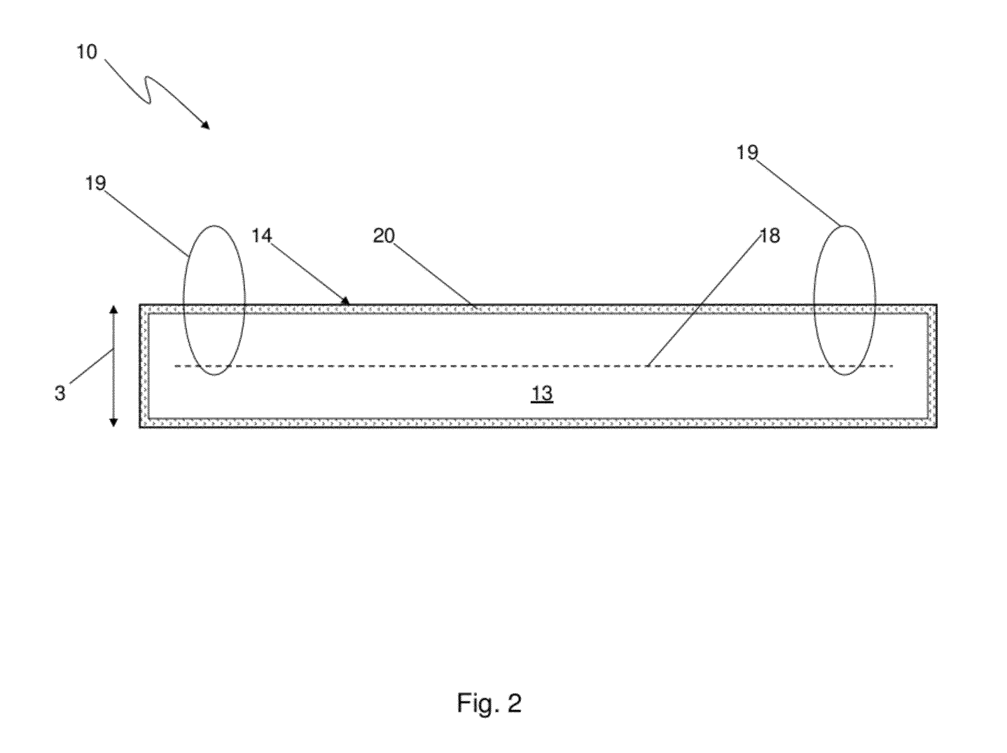

As shown in FIG. 2, the specific embodiment device 10 includes a 31 inch long by 25 inch wide piece of eighteen gauge wire mesh 18 disposed inside the cement 13 to reinforce the strength of the pad 10. However, other types of reinforcing materials may be used, and may extend throughout the entirety of the device 10, or, for example, within only portions of the main body 12, extension 16, or combinations thereof. As noted, a specific example of reinforcing material is 18 gauge wire mesh; however it is envisioned that 12 gauge wire mesh up to ½ inch rebar may be employed as reinforcing materials. In a specific embodiment, fibercrete is employed and so no internal reinforcing 18 is required.

The device 10 further includes a polymer coating 20. The polymer coating 20 covers at least the top surface of the main body 12, thereby providing the top surface 14 of the device 10. In preferred embodiments the polymer coating 20 completely encloses both the main body portion 12 and the extension portion 16. The polymer coating 20 may be of any color, and may be, for example, a latex paint, a plastic coating, a rubber coating, or the like. In addition, the device 10 preferably includes at least one handle 19. The handle 19 may be a rope, such as a nylon rope, and wraps around a portion of the reinforcing material 18 before exiting the concrete 13 of the main body portion 12. Preferably a handle 19 is installed on each side of the main body portion 12 to permit easy carrying of the device 10.

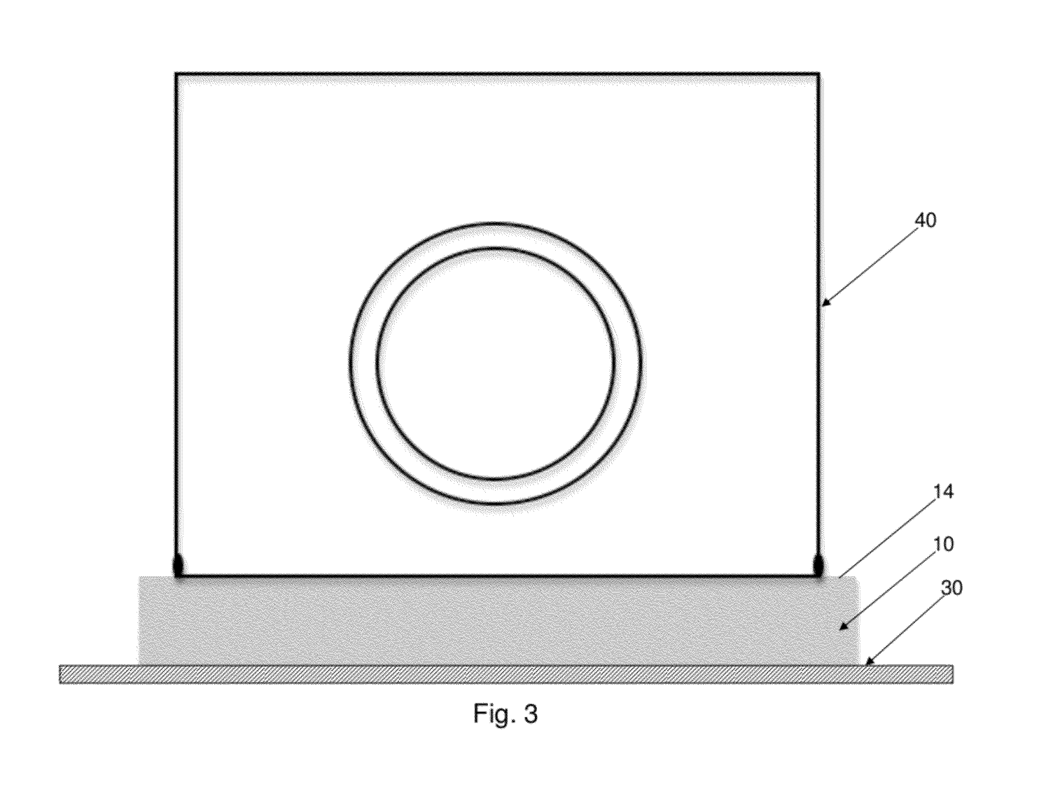

Another premise relating to the design and effectiveness of the device 10 comes from the utility of a subfloor in construction. Embodiments of the present invention are specifically designed to utilize the layout of the subfloor to maximize stability. In particular, the extension portion 16 provides greater stability and anti-vibration properties for the device 10. Subfloors are critical to the structural integrity of a building and are the immediate layer of planks or plywood that is laid over the floor joists. The present invention succeeds where previous attempts at solving this common problem of unwanted vibration, noise, and structural damage have failed in that it does not require anything to be done to the existing floor, thus maintaining the structural integrity of the floor and negating an entire host of issues that could arise from not doing so. It is the base of any other flooring laid upon it such as carpet, ceramic, linoleum, laminate or wood flooring. An aspect of the embodiment design is that is not dependent on a specific type of flooring surface and is designed to work on any and all flooring surfaces, each just as well as the next. This is particularly prescient given the diverse set of flooring surfaces that a washing machine can and is often found in, whether it be a residential or commercial environment that which the washing machine is stationed. As shown in FIG. 3, the device 10 may rest upon a floor 30, and an appliance 40, such as a washing machine, is placed on the top surface 14 of the device 10.

In construction, the subfloor is one of the most fundamental elements of interiors. By maintaining this fundamental element of the interior structure of the residential or commercial property, embodiments of the present invention thereby prevent any further destruction of the flooring, the machine itself, and any surrounding materials or structures. Without a stable, level floor, whatever is placed upon it will not live up to its claims of durability, longevity or other virtues. Therefore, by installing the device 10, the owner will essentially be reinforcing the already stable floor upon which the device 10 will sit; moreover, the device 10, being flat itself, can correct any unstable, non-level floor upon which the device 10 rests. This allows for a situation in which the issue of unstable flooring is eliminated thus allowing the device 10 to successfully keep the washing machine in proper working order.

In addition, a poorly installed subfloor can lead to serious problems with the integrity of the structure and lessen the effectiveness and longevity of many different appliances. It is specifically the lessened effectiveness and potential structural damage to these many different appliances that embodiments of the present invention are designed to protect against, among many other various ways in which this invention solves this common household or business issue.

Subfloors were previously constructed out of straight or diagonal planks of wood, however in current construction plywood is used almost ubiquitously because it is cheaper, lighter and easier to install. The lightness of the subfloor in newer constructed homes makes it more difficult to absorb all vibrations from washers and other devices leading to noise and shaking throughout a residence. It is for this specific reason that modern washing machines are more of a threat than ever before and that the potential for unwanted vibration, noise, structural damage, etc. can lead to an untold amount of damage and destruction that embodiments of the present invention are designed to eliminate. Various embodiments serve as strong, sturdy, heavy subfloors to be placed beneath a washer. The stable subfloor is that part of the invention which is allows it to successfully mitigate the many issues that may arise as previously discussed, not limited to, but including unit vibration, structural damage to surrounding structures, and noise disturbances as a result of the collision caused by a walking unit. In order to create a sufficiently heavy and strong device, preferred embodiments employ 4,000 psi concrete with ⅜″ stone. This level of stability provides more than enough thickness of material for the device 10 to absorb the unwanted vibrations as it is specifically designed to do. The concrete 13 is either air cured or baked in a kiln. Within the concrete 13 is, for example, 18-gauge wire mesh 18, which serves to buttress the structural integrity of the device 10 and stabilize the device for long-term use.

Embodiments of the present invention fit under any standard or compact size washing machine or dryer and can also be used under “stackable” laundry devices that feature the washing machine and dryer stacked upon one another, which is often found in apartments and smaller residences. The stackable feature of embodiments of the present invention and their ability to function to full capacity under two washing machine units just as well as they can under simply one washing machine unit is a factor that business owners will surely be attracted to given their propensity for fitting as many washing machine units into a limited amount of space so as to increase profit margins.

Any suitable method may be employed to create the device 10. By way of example, a first step in involves pouring 4,000 psi ⅜ inch stone cement into a customized mold, the mold having the desired shape of the device 10. Once half the cement has been poured a 31 inches long by 25 inches wide piece of 18-gauge wire mesh is placed on top of the cement. The remaining cement is then poured on top of the wire mesh and either air-dried or baked in a kiln. Weather conditions have a significant impact on the ability of the cement to properly harden in the air and for this reason baking the structure in a kiln is beneficial to the strength and longevity of the present invention but is not necessary.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the following claims.

What is claimed is:

1. An anti-vibration pad for an appliance, the anti-vibration pad comprising:
a substantially rectangular main body portion and an extension portion extending from a side of the main body portion, the extension portion having a width that is less than the width of the main body portion;
a reinforcing material disposed within at least the main body;
a polymer coating covering at least a top surface of the main body portion; and
at least a handle partially disposed in the main body and extending from the polymer coating.

2. The anti-vibration pad of claim 1 wherein the extension portion is integrally formed with the main body portion.

3. The anti-vibration pad of claim 1 wherein the main body portion comprises 4,000 psi cement with ⅜″ stone.

4. The anti-vibration pad of claim 3 wherein the main body portion has a thickness of 3.25 inches, a length of 32 inches and a width of 28 inches.

5. A method for insulating a structure from appliance vibration, the method comprising:
disposing the anti-vibration pad of claim 1 on a floor or subfloor of the structure; and
disposing the appliance on the anti-vibration pad.

6. The method of claim 5 wherein the appliance is a washing machine.
